(19) United States
(12) Patent Application Publication
(10) Pub. No.: US 2026/0368871 A1
(43) Pub. Date: Nov. 19, 2026

(54) Probe Deterioration Determination Method, Probe Deterioration Determination Apparatus, and Probe Deterioration Determination Program

(71) Applicant: SHIMADZU CORPORATION, Kyoto-shi, Kyoto (JP)

(72) Inventors: Kotomi KURODA, Kyoto-shi, Kyoto (JP); Masato HIRADE, Kyoto-shi, Kyoto (JP)

(73) Assignee: SHIMADZU CORPORATION, Kyoto-shi, Kyoto (JP)

(21) Appl. No.: 19/137,552

(22) PCT Filed: Oct. 18, 2023
(86) PCT No.: PCT/JP2023/037632

§ 371 Date: Jun. 10, 2025

(30) Foreign Application Priority Data
Jan. 11, 2023 (JP) 2023-002352

(51) Int. Cl. G06T 7/00; G01Q 30/02; G01Q 30/04

(52) U.S. Cl. CPC G06T 7/0002; G01Q 30/02; G01Q 30/04; G06T 2207/10056; G06T 2207/20081; G06T 2207/30168

(57) ABSTRACT

A computer performs steps of obtaining an image of a sample generated based on measurement with a scanning probe microscope (S20), obtaining deterioration information by inputting the image of the sample to a discriminator, the deterioration information indicating whether or not a probe of the scanning probe microscope has deteriorated (S30), and outputting the deterioration information (S50). The discriminator is subjected to training processing with training data to output the deterioration information when the image generated based on measurement with the scanning probe microscope is inputted.

### TECHNICAL FIELD

The present invention relates to determination of deterioration of a probe of a scanning probe microscope.

### BACKGROUND ART

A scanning probe microscope (SPM) observes asperities at a surface of a sample to be observed at a high resolution by scanning the surface of the sample with a sufficiently sharpened probe in a horizontal direction while the probe is sufficiently brought closer to the sample and moved up and down such that a physical quantity applied to a tip end of the probe and the surface of the sample is constant.

Evaluation of deterioration of the probe in the SPM has conventionally variously been studied. For example, Japanese Patent Laying-Open No. 2006-308312 (PTL 1) discloses a method of evaluating a tip end of a probe by using a dedicated sample (reference sample 11). Japanese Patent Laying-Open No. 2006-250637 (PTL 2) discloses a mechanism (probe length measurement mechanism 62) that estimates a state of wear of a probe based on a difference between a length of the probe and a length of the probe when it was new.

### CITATION LIST

### Patent Literature

PTL 1: Japanese Patent Laying-Open No. 2006-308312

PTL 2: Japanese Patent Laying-Open No. 2006-250637

### SUMMARY OF INVENTION

### Technical Problem

As described above, the conventional technique required special operations by using a dedicated sample or mechanism for evaluation of deterioration of the probe. Therefore, a user has been unable to recognize deterioration of the probe unless the user intends to evaluate deterioration of the probe. In other words, if the user continues measurement without consciousness about deterioration of the probe in spite of deterioration of the probe, observation with the deteriorated probe in the SPM may continue.

The present invention was made in view of such circumstances, and an object thereof is to provide a technique to reliably detect deterioration of a probe in an SPM without requiring user's consciousness about deterioration of the probe.

### Solution to Problem

A probe deterioration determination method according to one aspect of the present disclosure includes obtaining an image of a sample generated based on measurement with a scanning probe microscope, obtaining deterioration information by inputting the image of the sample to a discriminator, the deterioration information indicating whether a probe of the scanning probe microscope has deteriorated, and outputting the deterioration information, and the discriminator is subjected to training processing with training data to output the deterioration information when the image generated based on measurement with the scanning probe microscope is inputted.

A probe deterioration determination apparatus according to one aspect of the present disclosure includes at least one processor and a storage where a program to be executed by the at least one processor is stored, and the program, by being executed by the at least one processor, causes the at least one processor to perform the probe deterioration determination method described above.

A probe deterioration determination program according to one aspect of the present disclosure, by being executed by at least one processor, causes the at least one processor to perform the probe deterioration determination method described above.

### Advantageous Effects of Invention

According to one aspect of the present disclosure, a technique to reliably detect deterioration of a probe in an SPM without requiring user's consciousness about deterioration of the probe is provided.

### BRIEF DESCRIPTION OF DRAWINGS

FIG. 1 is a schematic diagram of a configuration of one embodiment of a measurement system including a scanning probe microscope.

FIG. 2 is a diagram showing an exemplary cantilever 113A for a contact mode.

FIG. 3 is a diagram showing an exemplary cantilever 113B for a dynamic mode.

FIG. 4 is a diagram showing an image of an exemplary pyramidal probe 114.

FIG. 5 is a diagram showing an image of an exemplary conical probe 114.

FIG. 6 is a diagram showing an image of an exemplary tetrahedral probe 114.

FIG. 7 is a diagram showing an exemplary state of the probe at the time of start of use and at the time after use for a certain time period.

FIG. 8 is a diagram for illustrating a manner of wear of pyramidal probe 114.

FIG. 9 is a diagram for illustrating a manner of wear of tetrahedral probe 114.

FIG. 10 is a diagram showing an exemplary image obtained with the use of probe 114 that has not deteriorated.

FIG. 11 is a diagram showing another exemplary image obtained with the use of probe 114 that has not deteriorated.

FIG. 12 is a diagram showing yet another exemplary image obtained with the use of probe 114 that has not deteriorated.

FIG. 13 is a diagram showing an exemplary image obtained with the use of probe 114 that has deteriorated.

FIG. 14 is a diagram showing an exemplary image obtained with the use of probe 114 that has deteriorated.

FIG. 15 is a diagram showing an exemplary image obtained with the use of probe 114 that has deteriorated.

FIG. 16 is a diagram showing an exemplary image obtained with the use of probe 114 that has deteriorated.

FIG. 17 is a diagram showing an exemplary image obtained with the use of probe 114 that has deteriorated.

FIG. 18 is a diagram showing an exemplary image obtained with the use of probe 114 that has deteriorated.

FIG. 19 is a diagram showing an exemplary image obtained with the use of probe 114 that has deteriorated.

FIG. 20 is a diagram showing an exemplary image obtained with the use of probe 114 that has deteriorated.

FIG. 21 is a flowchart of a process performed for determination of deterioration of the probe, on an image generated in a scanning probe microscope 1.

FIG. 22 is a diagram showing an exemplary output screen.

FIG. 23 is a diagram showing another exemplary output screen.

FIG. 24 is a diagram showing yet another exemplary output screen.

### DESCRIPTION OF EMBODIMENTS

An embodiment of the present invention will be described in detail with reference to the drawings. The same or corresponding elements in the drawings have the same reference characters allotted and description thereof will not be repeated.

### Schematic Configuration of Measurement System

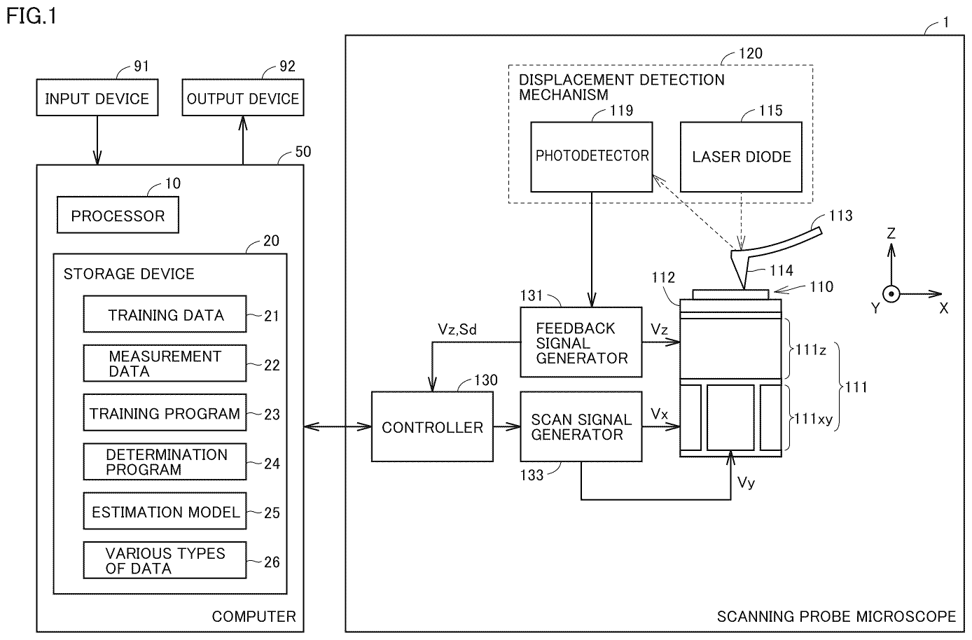

FIG. 1 is a schematic diagram of a configuration of one embodiment of a measurement system including a scanning probe microscope. The measurement system includes a scanning probe microscope 1 and a computer 50. An exemplary scanning probe microscope 1 is an atomic force microscope. The scanning probe microscope may be a scanning probe microscope of another type (for example, a scanning tunneling microscope). Scanning probe microscope 1 is configured to communicate with computer 50. Computer 50 includes an input device 91 (a keyboard, a mouse, and/or the like) and an output device 92 (a display, a speaker, and/or the like). A user inputs information to computer 50 with input device 91 and computer 50 outputs a result of computation through output device 92.

### Scanning Probe Microscope 1

As shown in FIG. 1, scanning probe microscope 1 includes a sample base 112 on which a sample 110 is carried, a piezo scanner 111 that displaces the sample base, a cantilever 113 provided with a probe 114 at a tip end, a displacement detection mechanism 120 that detects displacement of cantilever 113, a controller 130, a feedback signal generator 131, and a scan signal generator 133.

Piezo scanner 111 includes a Z scanner 111z that causes displacement in a Z direction based on a voltage value Vz and an XY scanner 111xy that causes displacement in an XY direction based on voltage values Vx and Vy.

Displacement detection mechanism 120 includes a laser diode 115 and a photodetector 119. When surface observation is performed in scanning probe microscope 1 by bringing the tip end of probe 114 closer to sample 110, laser beams emitted from laser diode 115 are reflected on a rear surface of cantilever 113 and reflected light is received by photodetector 119. As probe 114 is brought closer to a surface of sample 110, cantilever 113 is deflected like a leaf spring and hence an amount of deflection is observed at a position of light reception by photodetector 119.

Feedback signal generator 131 receives a detection signal from photodetector 119. Feedback signal generator 131 calculates the amount of deflection of cantilever 113 based on the detection signal. Feedback signal generator 131 controls a Z-direction position of the sample such that atomic force between probe 114 and the surface of sample 110 is always constant. Feedback signal generator 131 calculates voltage value Vz that causes displacement of piezo scanner 111 in the Z-axis direction based on the amount of deflection of cantilever 113 and outputs the voltage value to Z scanner 111z.

Scan signal generator 133 calculates voltage values Vx and Vy in an X-axis direction and a Y-axis direction such that sample 110 moves relatively to probe 114 in an X-Y plane in accordance with a predetermined scan pattern and outputs the voltage values to XY scanner 111xy.

A signal on which an amount of feedback (a voltage Vz applied to the scanner and a difference signal Sd) in the Z-axis direction is reflected is sent also to controller 130. The signal is stored in a storage device in controller 130 and transmitted to computer 50.

Controller 130 calculates an amount of displacement of the surface caused by asperities of sample 110 from voltage Vz, based on correlation information representing relation between voltage Vz stored in the storage device in controller 130 and the amount of displacement of the surface caused by the asperities of sample 110 corresponding thereto. Controller 130 reproduces a three-dimensional image of the surface of the sample by calculating the amount of displacement at each position in the X-axis direction and the Y-axis direction and transmits the three-dimensional image to computer 50. Data of this three-dimensional image is stored also in the storage device of controller 130. Controller 130 can perform height correction of the data of the three-dimensional image as necessary.

### Computer 50

Computer 50 includes a processor 10 and a storage device 20. Processor 10 may be implemented by at least one central processing unit (CPU).

Various types of data are stored in a non-volatile (non-transitory) manner in storage device 20. In the example in FIG. 1, training data 21, measurement data 22, a training program 23, a determination program 24, an estimation model 25, and various types of data 26 are stored in storage device 20.

Computer 50 functions as a probe deterioration determination apparatus that determines whether or not probe 114 has deteriorated. In this case, processor 10 obtains a result of identification as to whether or not probe 114 used for measurement of a three-dimensional image generated in scanning probe microscope 1 has deteriorated, by inputting the three-dimensional image to estimation model 25. In one implementation, estimation model 25 obtains at least one type of feature value from the inputted image and derives a result of identification of the inputted image based on the at least one type of feature value.

Training data 21 is a data set to be used for machine learning by estimation model 25. Data included in the data set is generated by labeling with ground truth (information indicating whether or not the probe has deteriorated), of an image generated based on measurement with the scanning probe microscope. In one implementation, labeling is performed by a user who has looked at each image. More specifically, the user determines whether or not the image was obtained with the deteriorated probe, and labels the image in accordance with a result of determination. Training data 21 may include only images generated in scanning probe microscope 1 or images generated in another scanning probe microscope.

Measurement data 22 is an image for which determination as to deterioration of probe 114 is to be made, the image being generated based on measurement with scanning probe microscope 1.

Training program 23 is a program for training of estimation model 25 with training data 21. In one implementation, processor 10 executes training program 23 to perform machine learning of estimation model 25.

Determination program 24 is a program for determination of deterioration of probe 114 based on measurement data 22. In one implementation, processor 10 executes determination program 24 to input measurement data 22 to estimation model 25 and thus to obtain deterioration information indicating whether or not probe 114 has deteriorated.

Estimation model 25 includes data (for example, a parameter of a model) for configuration of a discriminator. A type of the discriminator implemented by estimation model 25 is not restricted, so long as it is a model capable of outputting deterioration information as to whether or not probe 114 used for generation of an image based on measurement with scanning probe microscope 1 has deteriorated, by receiving input of the image. The discriminator may be a classification model such as a support vector machine or a model constructed of neural networks. The deterioration information may be information indicating a class (a class that the probe has deteriorated or a class that the probe has not deteriorated) into which images are classified or information indicating a degree relating to deterioration (not deteriorated, slightly deteriorated, considerably deteriorated, or the like).

Various types of data 26 are data other than the above, and include data (setting, a program, or the like) that allows computer 50 to perform functions described herein.

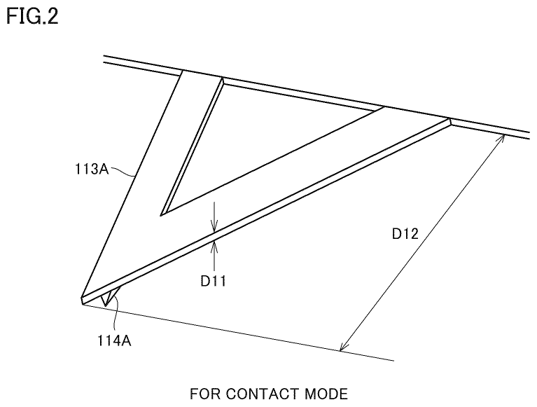

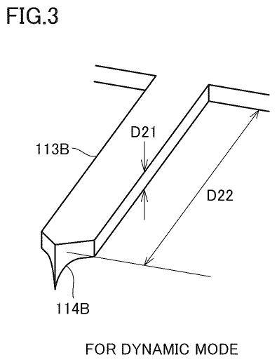

As described above, processor 10 executes training program 23 to train estimation model 25 with training data 21. Training data 21 may further be labeled with a measurement mode of the scanning probe microscope at the time of generation of an image. The measurement mode is, for example, a contact mode or a dynamic mode which will be described later with reference to FIGS. 2 and 3. The measurement mode is thus used for output of deterioration information, and improvement in accuracy of deterioration information to be outputted is expected. In this case, measurement data 22 is also preferably provided with the measurement mode in scanning probe microscope 1.

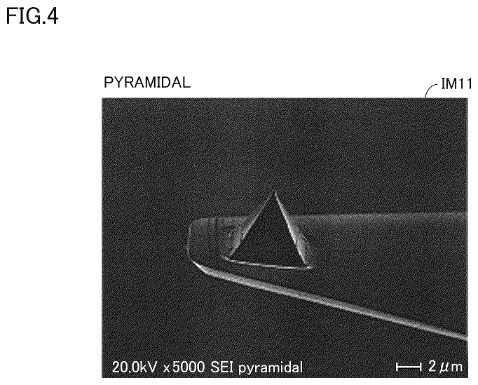

Training data 21 may further be labeled with a type of the probe that has been used in the scanning probe microscope when an image is generated. The type of probe 114 is, for example, a pyramidal type, a conical type, or a tetrahedral type which will be described later with reference to FIGS. 4 to 6. The type of the probe is thus used in output of the deterioration information, and improvement in accuracy of deterioration information to be outputted is expected. In this case, measurement data 22 is also preferably provided with the type of probe 114 used in scanning probe microscope 1.

Training data 21 may be labeled with both of the measurement mode and the type of the probe described above. In this case, measurement data 22 is also preferably provided with both of the measurement mode in scanning probe microscope 1 and the type of probe 114.

### Measurement Mode

The measurement mode in scanning probe microscope 1 will be described.

An exemplary measurement mode is the contact mode. The contact mode is a mode in which static atomic force is detected based on a degree of warpage of cantilever 113.

FIG. 2 is a diagram showing an exemplary cantilever 113A for the contact mode. For example, silicon nitride is employed as a material for cantilever 113A. In the example in FIG. 2, cantilever 113A includes a probe 114A, a thickness represented by D11 is approximately 1 μm, and a length represented by D12 is approximately 200 μm.

Another exemplary measurement mode is the dynamic mode. In the dynamic mode, excitation in a vertical direction (a direction in which cantilever 113 is opposed to sample 110) is applied to cantilever 113. As excitation is applied, cantilever 113 oscillates around a resonance frequency. As probe 114 comes closer to the sample in this state, an amplitude is varied. In the dynamic mode, this phenomenon is used to generate a result of surface observation of the sample based on a control amount in feedback control to set the amplitude of oscillation of cantilever 113 constant.

FIG. 3 is a diagram showing an exemplary cantilever 113B for the dynamic mode. For example, silicon is employed as a material for cantilever 113B. In the example in FIG. 3, cantilever 113B includes probe 114A, a thickness represented by D21 is approximately 5 μm, and a length represented by D22 is approximately 100 μm.

### Type of Probe

Probe 114 to be used in scanning probe microscope 1 can be classified based on a geometry thereof.

An exemplary type of probe 114 is a pyramidal type. FIG. 4 is a diagram showing an image of an exemplary pyramidal probe 114. In an image IM11 in FIG. 4, probe 114 has a tip end located above. As shown in image IM11, exemplary probe 114 is in a pyramidal shape.

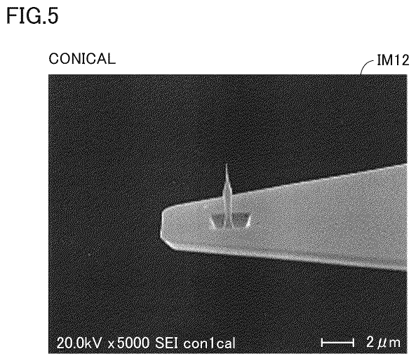

Another exemplary type of probe 114 is a conical type. FIG. 5 is a diagram showing an image of an exemplary conical probe 114. In an image IM12 in FIG. 5, probe 114 has a tip end located above. As shown in image IM12, exemplary probe 114 is in a conical shape.

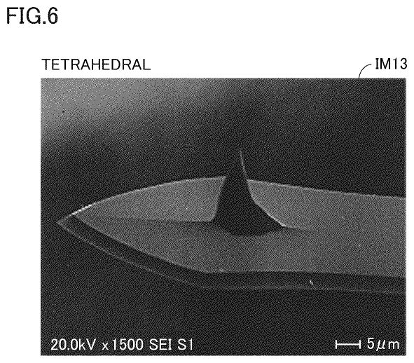

Yet another exemplary type of probe 114 is a tetrahedral type. FIG. 6 is a diagram showing an image of an exemplary tetrahedral probe 114. In an image IM13 in FIG. 6, probe 114 has a tip end located above. As shown in image IM13, exemplary probe 114 is in a tetrahedral shape.

### Deterioration of Probe

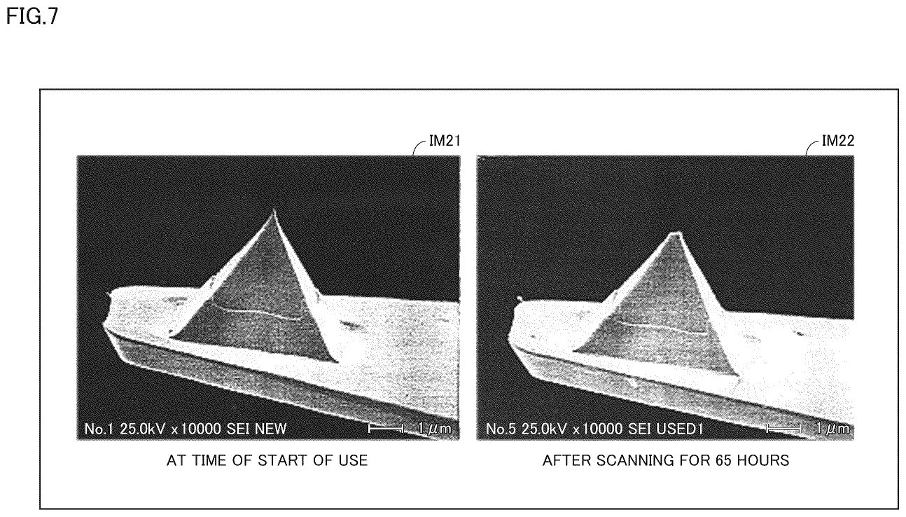

FIG. 7 is a diagram showing an exemplary state of the probe at the time of start of use and at the time after use for a certain time period. FIG. 7 shows an image IM21 as an exemplary state at the time of start of use and shows an image IM22 as an exemplary state after use for measurement (scanning) for 65 hours. In each of image IM21 and image IM22, probe 114 has the tip end located above. It is understood based on comparison between image IM21 and image IM22 that the tip end of probe 114 has been worn by use.

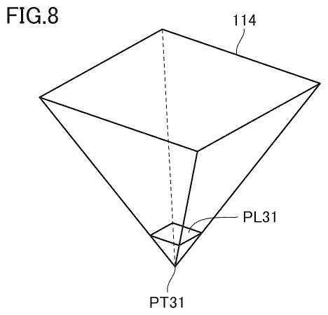

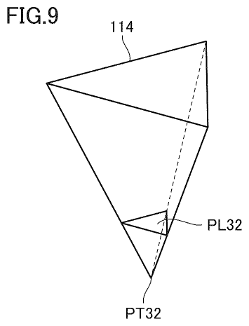

FIG. 8 is a diagram for illustrating a manner of wear of pyramidal probe 114. FIG. 9 is a diagram for illustrating a manner of wear of tetrahedral probe 114.

In both of FIGS. 8 and 9, probe 114 has the tip end located below. As shown in FIG. 8, the tip end of probe 114 varies from a point PT31 to a plane PL31 due to wear. Since probe 114 in FIG. 8 is of the pyramidal type, plane PL31 is in a quadrangular shape. Alternatively, as shown in FIG. 9, the tip end of probe 114 varies from a point PT32 to a plane PL32 due to wear. Since probe 114 in FIG. 9 is of the tetrahedral type, plane PL32 is in a triangular shape. In other words, when the type of probe 114 is different, the shape of the tip end varied by wear may be different.

“Wear” is exemplary deterioration of probe 114. Deterioration of probe 114 may occur also as a phenomenon other than wear, such as crack at the tip end of probe 114, like what is called double tips.

### Specific Example of Image Obtained with Probe That Has Not Deteriorated

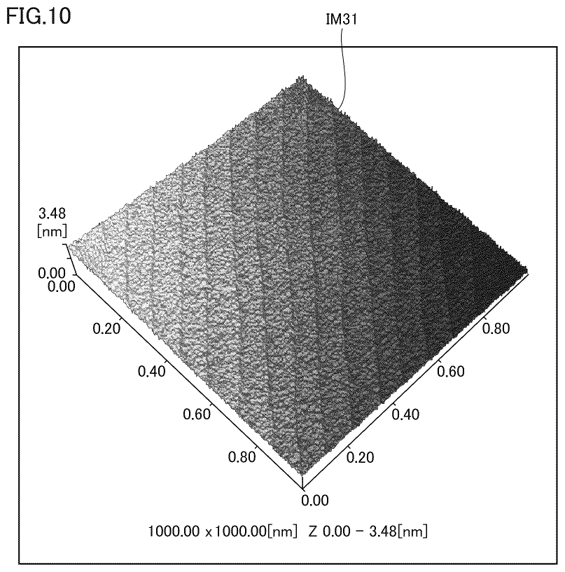

FIG. 10 is a diagram showing an exemplary image obtained with the use of probe 114 that has not deteriorated. An image IM31 in FIG. 10 shows a result of observation of a 1.00 μm-square at a surface of a sapphire substrate. A height is 3.48 nm. As shown in image IM31, atomic steps at the surface of the sapphire substrate are clearly observed in results of measurement.

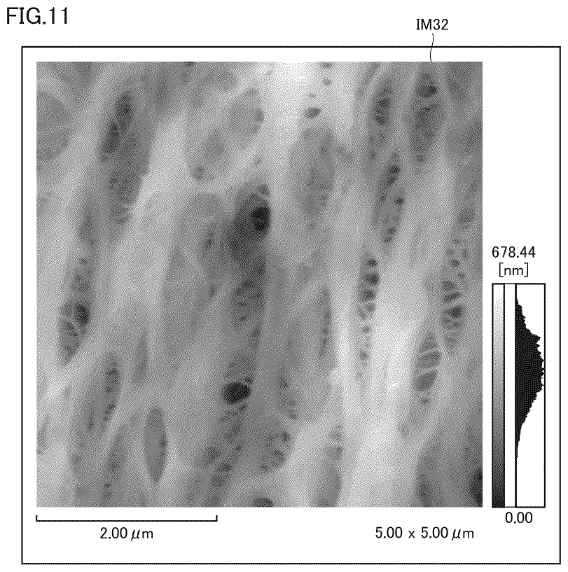

FIG. 11 is a diagram showing another exemplary image obtained with the use of probe 114 that has not deteriorated. An image IM32 in FIG. 11 shows a result of observation of a 5.00 μm-square at a surface of a lithium ion battery (separator). A height is 678.4 nm. As shown in image IM32, pores at the surface of the lithium ion battery are observed in results of measurement.

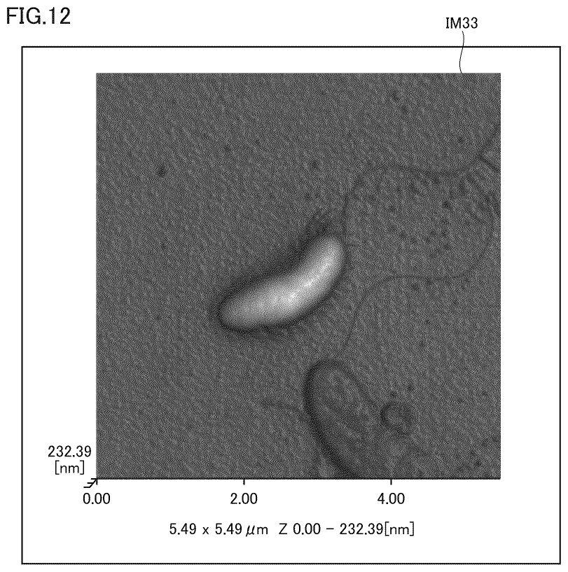

FIG. 12 is a diagram showing yet another exemplary image obtained with the use of probe 114 that has not deteriorated. An image IM33 in FIG. 12 shows a result of observation of a 5.49 μm-square of vibrio cholerae (not stained). A height is 232.39 nm. As shown in image IM33, a curved cell body specific to vibrio cholerae and one flagellum present at one end of the cell body are clearly observed in results of measurement.

### Specific Example of Image Obtained with Probe That Has Deteriorated

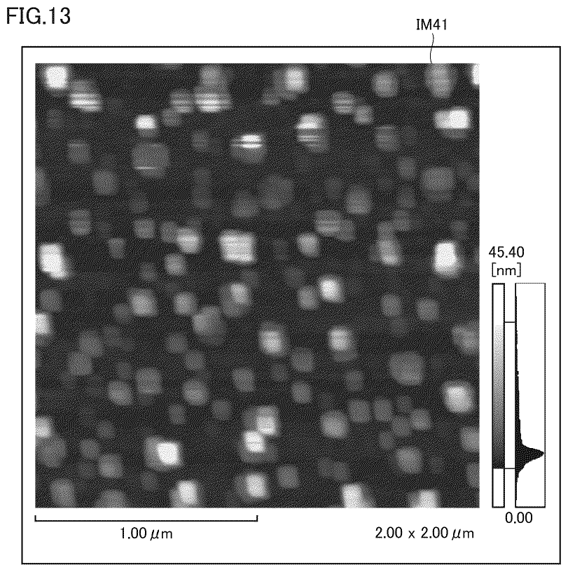

Each of FIGS. 13 to 20 is a diagram showing an exemplary image obtained with the use of probe 114 that has deteriorated.

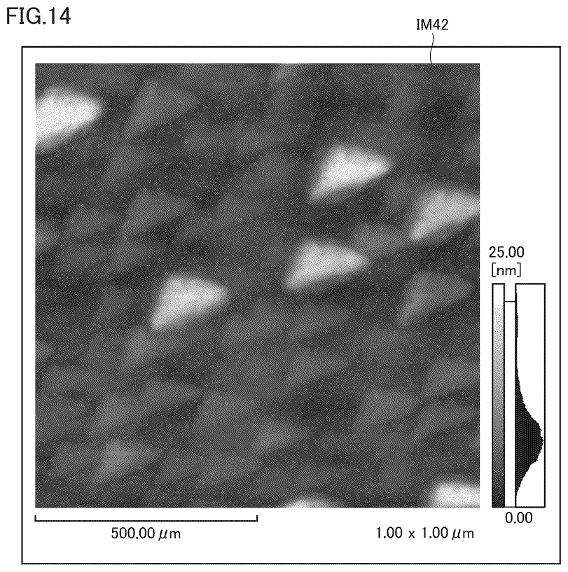

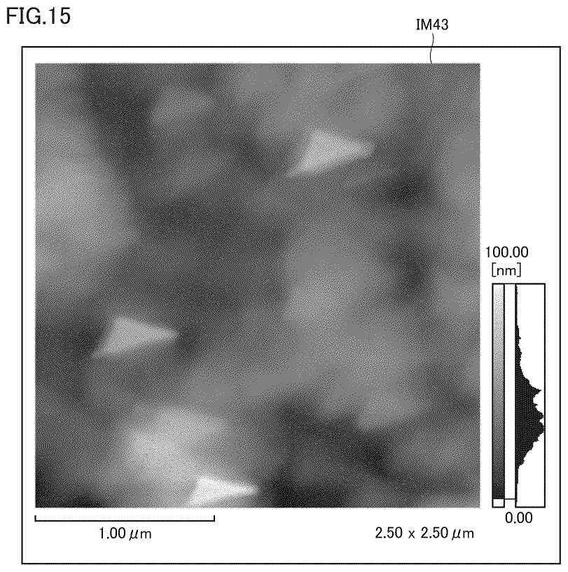

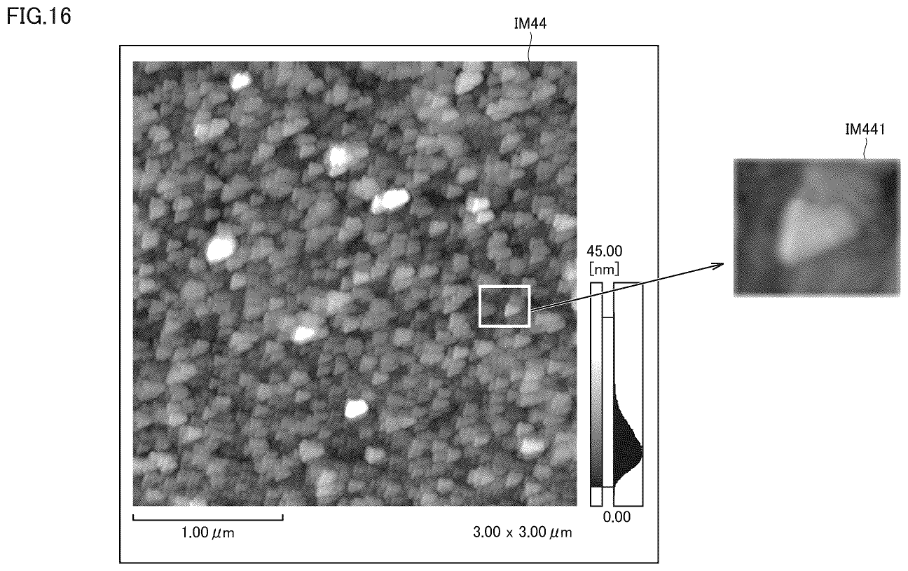

An image IM41 in FIG. 13 shows an area of a 2.00 μm-square. An image IM42 in FIG. 14 shows an area of a 1.00 μm-square. An image IM43 in FIG. 15 shows an area of a 2.50 μm-square. An image IM44 in FIG. 16 shows an area of a 3.00 μm-square. In each of images IM41 to IM44, an object in a shape assumed to represent a cross-sectional shape of the tip end of probe 114 repeatedly appears all over. For example, in image IM41, a quadrangular object repeatedly appears all over, and in images IM42 and IM43, a triangular object repeatedly appears all over.

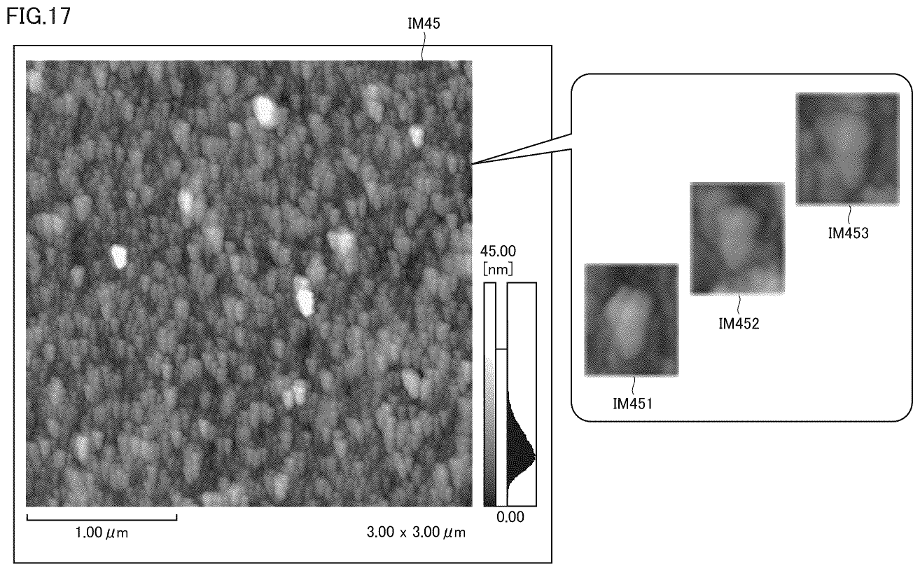

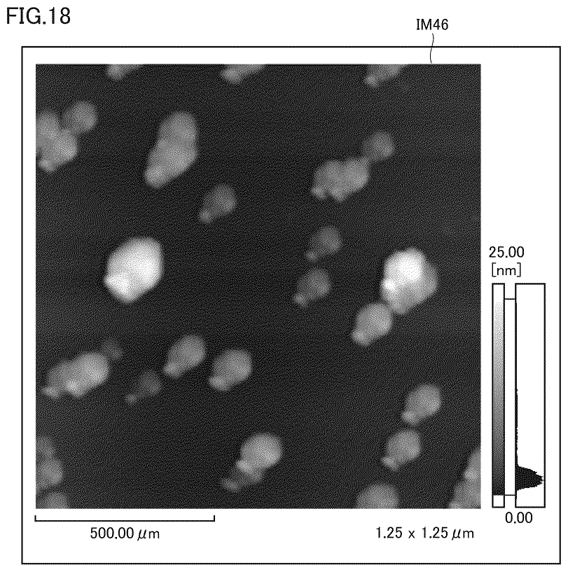

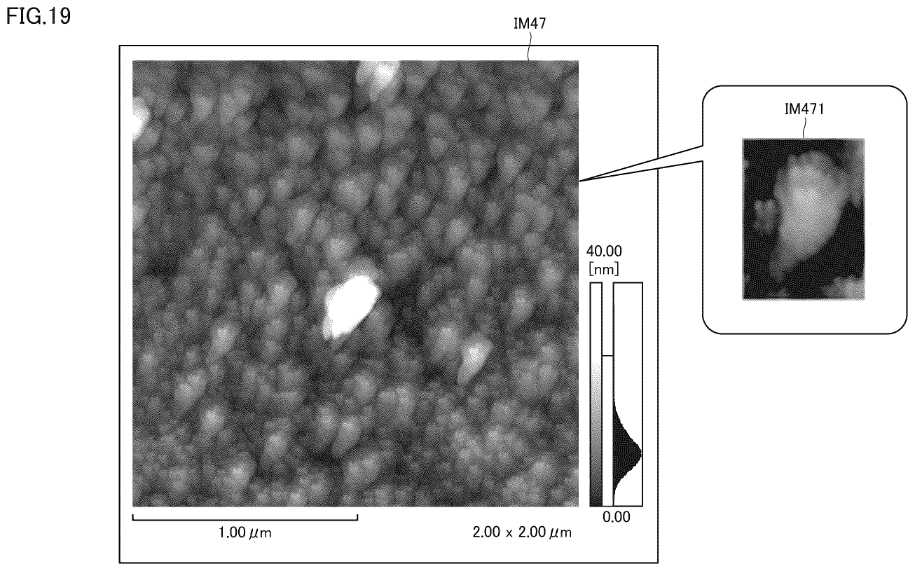

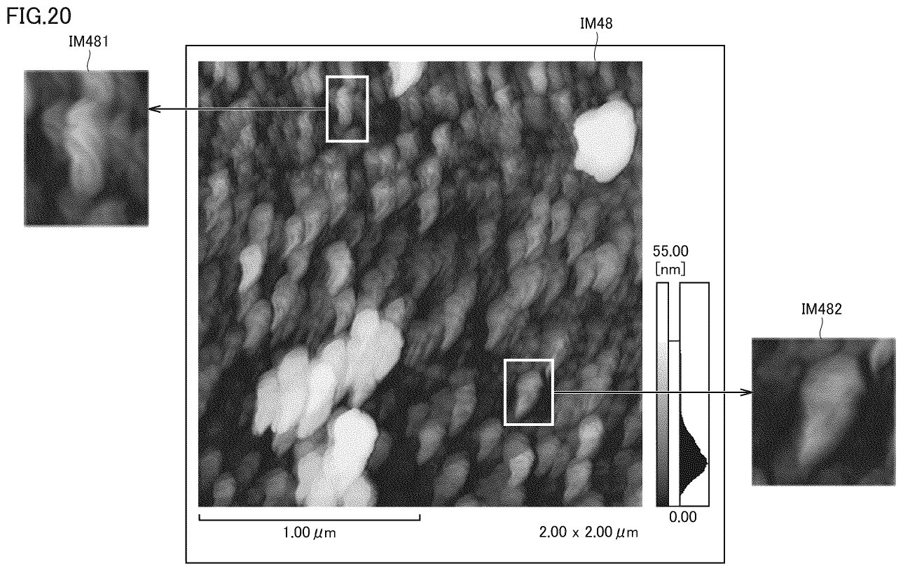

An image IM45 in FIG. 17 shows an area of a 3.00 μm-square. An image IM46 in FIG. 18 shows an area of a 1.25 μm-square. Each of an image IM47 in FIG. 19 and an image IM48 in FIG. 20 shows an area of a 2.00 μm-square. In each of images IM45 to IM48, an object in a given shape repeatedly appears all over. For example, in image IM45 in FIG. 17, an object shown as being enlarged in each of images IM451, IM452, and IM453 in FIG. 17 repeatedly appears all over. In image IM47 in FIG. 19, an object shown as being enlarged in an image IM471 in FIG. 19 repeatedly appears all over. In image IM48 in FIG. 20, an object shown as being enlarged in each of images IM481 and IM482 in FIG. 20 repeatedly appears all over.

As set forth above, when the probe has deteriorated, an identical object repeatedly appears all over the image. The shape of the object that repeatedly appears, however, is not constant, and a manner of repetition is not constant either. Therefore, a skilled user may notice repeated appearance of the object and derive deterioration of the probe. A less experienced user, however, may look over repeated appearance of object and fail to derive deterioration of the probe. For various reasons including the shape and/or the manner of the repeatedly appearing object not being constant, for determination of deterioration of the probe with the obtained image, determination using the discriminator subjected to machine learning is preferable to determination based on rules (rule-based determination) predetermined in connection with deterioration.

### Process Flow

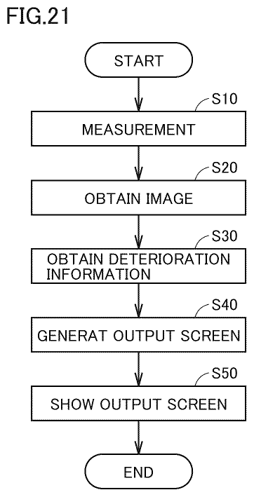

FIG. 21 is a flowchart of a process performed for determination of deterioration of the probe, on an image generated in scanning probe microscope 1. In one implementation, computer 50 performs the process in FIG. 21 by execution of determination program 24 by processor 10. In one implementation, computer 50 starts the process in FIG. 21 in response to input of an instruction for measurement to input device 91.

As shown in FIG. 21, in step S10, computer 50 instructs scanning probe microscope 1 to start measurement of sample 110. In response, scanning probe microscope 1 generates an image of sample 110 and transmits the generated image (measurement data 22) to computer 50.

In step S20, computer 50 obtains (receives) the image generated as described above from scanning probe microscope 1.

In step S30, computer 50 obtains deterioration information based on the image obtained in step S20. More specifically, computer 50 inputs the image to estimation model 25 and generates the deterioration information by using output from estimation model 25.

In step S40, computer 50 generates an output screen from the image obtained in step S20 and the deterioration information obtained in step S30.

In step S50, computer 50 causes output device 92 to show the image generated in step S40. Thereafter, computer 50 quits the process in FIG. 21.

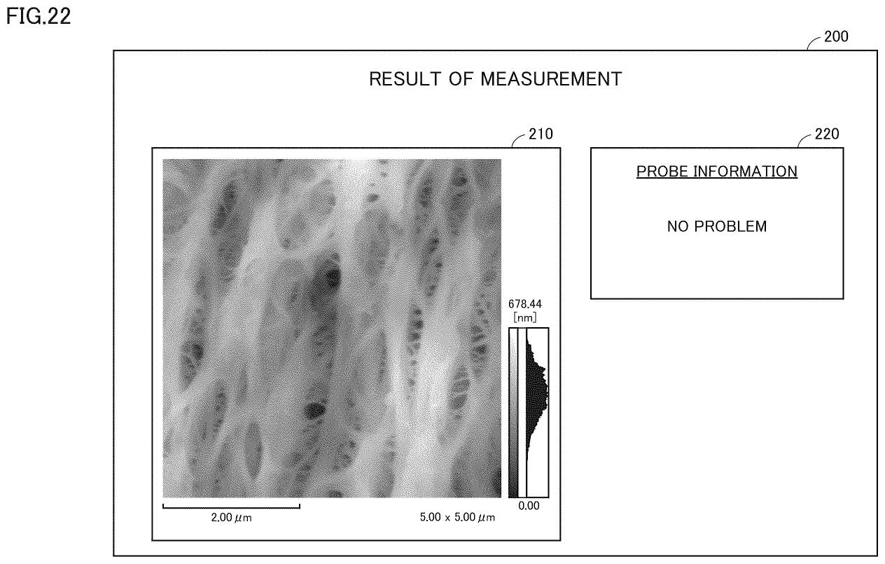

FIG. 22 is a diagram showing an exemplary output screen. An output screen 200 shown in FIG. 22 includes frames 210 and 220. In the example in FIG. 22, a result of measurement is shown within frame 210. The deterioration information is shown within frame 220. In the example in FIG. 22, the deterioration information indicates that probe 114 has not deteriorated. Thus, a message “no problem” is shown within frame 220 as probe information.

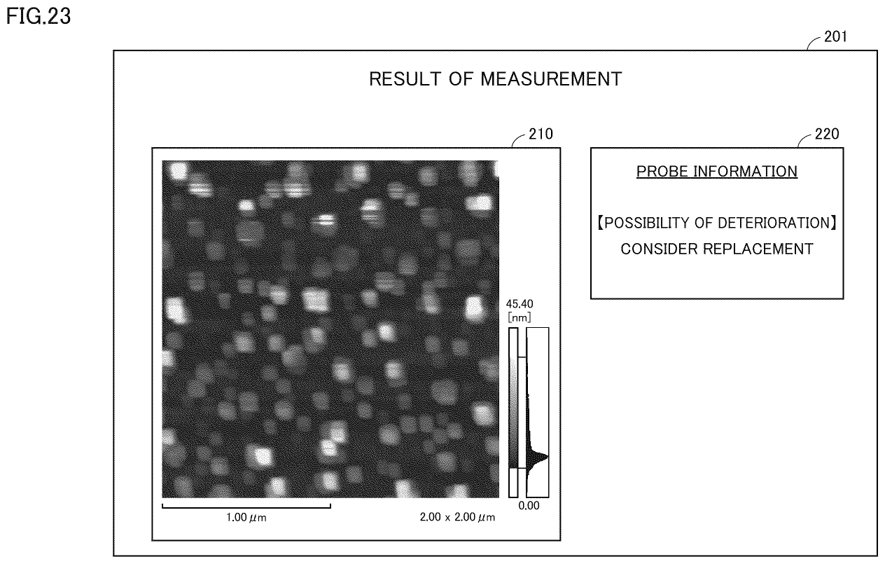

FIG. 23 is a diagram showing another exemplary output screen. An output screen 201 shown in FIG. 23 includes frames 210 and 220, similarly to output screen 200 in FIG. 22. In the example in FIG. 23, the deterioration information indicates that probe 114 has deteriorated. Thus, a message “possibility of deterioration_consider replacement” is shown within frame 220 as the probe information.

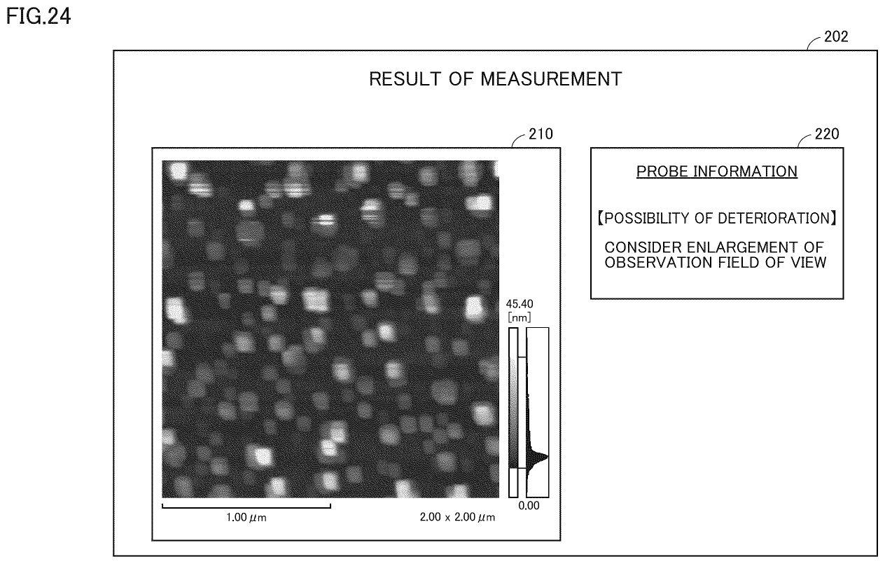

FIG. 24 is a diagram showing yet another exemplary output screen. An output screen 202 shown in FIG. 24 includes frames 210 and 220, similarly to output screen 200 in FIG. 22. In the example in FIG. 24, the deterioration information indicates that probe 114 has deteriorated. Thus, a message “possibility of deterioration_consider enlargement of observation field of view” is shown within frame 220 as the probe information.

In the present embodiment described above, the image obtained as the result of measurement of sample 110 in scanning probe microscope 1 is used to generate the deterioration information of probe 114 used for measurement, and the deterioration information is outputted. A manner of output of the deterioration information is not limited to “representation” described with reference to FIGS. 22 to 24. The manner of output of the deterioration information may be implemented by turn-on of a given indicator, output of sound, or combination thereof.

The deterioration information may indicate a degree of deterioration (not deteriorated, slightly deteriorated, considerably deteriorated, or the like) rather than whether or not the probe has deteriorated.

The deterioration information is generated with the use of estimation model 25. The deterioration information can thus be generated with the use of the image, even when a factor (a type of a feature value or the like) that affects the degree of deterioration of probe 114 is not clarified in the image.

When the deterioration information indicates that probe 114 has deteriorated, replacement of probe 114 may be encouraged as described with reference to FIG. 23, or enlargement of the observation field of view may be encouraged as described with reference to FIG. 24. In the latter case, the user may measure the same sample 110 again with the observation field of view being enlarged in scanning probe microscope 1.

To the image obtained from scanning probe microscope 1 in step S20, information indicating the measurement mode in scanning probe microscope 1 may be added, information indicating the type of the probe used in scanning probe microscope 1 may be added, an observation condition (for example, information defining dimensions in two directions defining the observation field of view) may be added, or two or more types of information freely selected from these three types may be added. If estimation model 25 is trained with training data 21 to which such information has been added, the measurement mode and/or the type of the probe added to the obtained image is/are reflected on the deterioration information generated based on output from estimation model 25, and improvement in accuracy of the degree of deterioration obtained as the result of determination is thus expected.

The image used as training data 21 and measurement data 22 preferably has pixels in number large to some extent. In one implementation, in both of a first direction (for example, lateral) and a second direction (for example, vertical), the number of pixels is preferably equal to or more than 64 dots, further preferably equal to or more than 128 dots, and still preferably equal to or more than 256 dots.

As described with reference to FIGS. 22 to 24, in output of the results of measurement of the sample, the deterioration information is preferably outputted on a screen the same as a screen where the results of measurement are shown. The user can thus obtain information on deterioration of probe 114 without consciousness about deterioration of probe 114 when the user conducts measurement of the sample with scanning probe microscope 1.

In the embodiment described above, computer 50 is described as an apparatus outside scanning probe microscope 1. Computer 50 may be implemented as a part of scanning probe microscope 1. Computer 50 may be implemented as one information processing apparatus or a plurality of information processing apparatuses in coordination.

### Aspects

Illustrative embodiments described above are understood by a person skilled in the art as specific examples of aspects below.

(Clause 1) A probe deterioration determination method according to one aspect includes obtaining an image of a sample generated based on measurement with a scanning probe microscope, obtaining deterioration information by inputting the image of the sample to a discriminator, the deterioration information indicating whether a probe of the scanning probe microscope has deteriorated, and outputting the deterioration information, and the discriminator may be subjected to training processing with training data to output the deterioration information when the image generated based on measurement with the scanning probe microscope is inputted.

According to the probe deterioration determination method described in Clause 1, a technique to reliably detect deterioration of the probe in the SPM without requiring user's consciousness about deterioration of the probe is provided.

(Clause 2) In the probe deterioration determination method described in Clause 1, the outputting the deterioration information may include outputting information that proposes replacement of the probe and/or information that proposes enlargement of an observation field of view in measurement with the scanning probe microscope, when the deterioration information indicates deterioration of the probe.

According to the probe deterioration determination method described in Clause 2, the user is provided with information that serves as reference for specific measures to be taken that correspond to the deterioration information, in addition to the deterioration information.

(Clause 3) In the probe deterioration determination method described in Clause 1 or 2, the discriminator may be subjected to training processing with training data to output the deterioration information indicating whether the probe of the scanning probe microscope has deteriorated in response to input of the image generated based on measurement with the scanning probe microscope and associated with a measurement mode of the scanning probe microscope, and the obtaining an image of a sample may include obtaining the measurement mode of the scanning probe microscope associated with the image of the sample.

According to the probe deterioration determination method described in Clause 3, accuracy of the deterioration information is improved.

(Clause 4) In the probe deterioration determination method described in any one of Clauses 1 to 3, the discriminator may be subjected to training processing with training data to output the deterioration information indicating whether the probe of the scanning probe microscope has deteriorated in response to input of the image generated based on measurement with the scanning probe microscope and associated with a type of the probe of the scanning probe microscope, and the obtaining an image of a sample may include obtaining the type of the probe of the scanning probe microscope associated with the image of the sample.

According to the probe deterioration determination method described in Clause 4, accuracy of the deterioration information is improved.

(Clause 5) In the probe deterioration determination method described in any one of Clauses 1 to 4, the image obtained in the obtaining an image of a sample may have pixels in number equal to or more than 64 dots in each of a first direction and a second direction.

According to the probe deterioration determination method described in Clause 5, accuracy of the deterioration information is improved.

(Clause 6) In the probe deterioration determination method described in any one of Clauses 1 to 5, the outputting the deterioration information may include outputting a screen that shows a result of the measurement together with the deterioration information.

According to the probe deterioration determination method described in Clause 6, the user who is attempting to obtain only the result of measurement of the sample is provided with information on deterioration of the probe in addition to the result of measurement, and the user can reliably have consciousness about deterioration of the probe.

(Clause 7) A probe deterioration determination apparatus according to one aspect includes at least one processor and a storage where a program to be executed by the at least one processor is stored, and the program, by being executed by the at least one processor, may cause the at least one processor to perform the probe deterioration determination method described in any one of Clauses 1 to 6.

According to the probe deterioration determination apparatus described in Clause 7, a technique to reliably detect deterioration of the probe in the SPM without requiring user's consciousness about deterioration of the probe is provided.

(Clause 8) A probe deterioration determination program according to one aspect may cause, by being executed by at least one processor, the at least one processor to perform the probe deterioration determination method described in any one of Clauses 1 to 6.

According to the probe deterioration determination program described in Clause 8, a technique to reliably detect deterioration of the probe in the SPM without requiring user's consciousness about deterioration of the probe is provided.

It should be understood that the embodiment disclosed herein is illustrative and non-restrictive in every respect. The scope of the present disclosure is defined by the terms of the claims rather than the description of the embodiment above and is intended to include any modifications within the scope and meaning equivalent to the terms of the claims. It is intended that each technique in the embodiment can be carried out alone or in combination to the extent possible with another technique in the embodiment as necessary.

### REFERENCE SIGNS LIST

1 scanning probe microscope; 10 processor; 20 storage device; 25 estimation model; 50 computer; 91 input device; 92 output device; 110 sample; 111 piezo scanner; 111xy XY scanner; 111z Z scanner; 112 sample base; 113 cantilever; 114 needle; 115 laser diode; 119 photodetector; 120 displacement detection mechanism; 130 controller; 131 feedback signal generator; 133 scan signal generator.

1. A probe deterioration determination method comprising:
obtaining an image of a sample generated based on measurement with a scanning probe microscope;
obtaining deterioration information by inputting the image of the sample to a discriminator, the deterioration information indicating whether a probe of the scanning probe microscope has deteriorated; and
outputting the deterioration information, wherein
the discriminator is subjected to training processing with training data to output the deterioration information when the image generated based on measurement with the scanning probe microscope is inputted.

2. The probe deterioration determination method according to claim 1, wherein
the outputting the deterioration information includes outputting information that proposes replacement of the probe and/or information that proposes enlargement of an observation field of view in measurement with the scanning probe microscope, when the deterioration information indicates deterioration of the probe.

3. The probe deterioration determination method according to claim 1, wherein
the discriminator is subjected to training processing with training data to output the deterioration information indicating whether the probe of the scanning probe microscope has deteriorated in response to input of the image generated based on measurement with the scanning probe microscope and associated with a measurement mode of the scanning probe microscope, and
the obtaining an image of a sample includes obtaining the measurement mode of the scanning probe microscope associated with the image of the sample.

4. The probe deterioration determination method according to claim 1, wherein
the discriminator is subjected to training processing with training data to output the deterioration information indicating whether the probe of the scanning probe microscope has deteriorated in response to input of the image generated based on measurement with the scanning probe microscope and associated with a type of the probe of the scanning probe microscope, and
the obtaining an image of a sample includes obtaining the type of the probe of the scanning probe microscope associated with the image of the sample.

5. The probe deterioration determination method according to claim 1, wherein
the image obtained in the obtaining an image of a sample has pixels in number equal to or more than 64 dots in each of a first direction and a second direction.

6. The probe deterioration determination method according to claim 1, wherein
the outputting the deterioration information includes outputting a screen that shows a result of the measurement together with the deterioration information.

7. A probe deterioration determination apparatus comprising:
at least one processor; and
a storage where a program to be executed by the at least one processor is stored, wherein
the program, by being executed by the at least one processor, causes the at least one processor to perform the probe deterioration determination method according to claim 1.

8. A method for machine learning by a discriminator to be used for deterioration determination of a probe of a scanning probe microscope, comprising:
reading training data, the training data being generated by labeling an image generated in measurement in the scanning probe microscope with information indicating whether the probe has deteriorated in the measurement; and
using the training data to perform a machine learning process on the discriminator.

9. The method for machine learning by a discriminator according to claim 8, wherein
the training data is further labeled with a measurement mode of the scanning probe microscope.

10. The method for machine learning by a discriminator according to claim 8, wherein
the training data is further labeled with a type of the probe.
